(19) United States
(12) Patent Application Publication
(10) Pub. No.: US 2011/0017182 A1
(43) Pub. Date: Jan. 27, 2011

(54) TWO-STROKE INTERNAL COMBUSTION ENGINE

(75) Inventor: Naoki Koga, Tokyo (JP)

Correspondence Address: BAKER BOTTS L.L.P., 30 ROCKEFELLER PLAZA, 44TH FLOOR, NEW YORK, NY, 10112-4498, US

(73) Assignee: Yamabiko Corporation, Tokyo (JP)

(21) Appl. No.: 12/842,625

(22) Filed: Jul. 23, 2010

(30) Foreign Application Priority Data
Jul. 24, 2009 (JP) 2009-172991

(51) Int. Cl. F02B 25/14

(52) U.S. Cl. 123/73 PP

(57) ABSTRACT

There is provided a loop-scavenged two-stroke internal combustion engine that is capable of effectively suppressing the short-circuiting of fresh charge (unburnt air-fuel mixture), while at the same time being capable of further improving scavenging efficiency, combustion efficiency, etc., as well as of improving the durability and output stability of a cylinder and a piston. One pair or a plurality of pairs of scavenging passages (31, 31 and 32, 32) that adopt a reverse scavenging system are so provided as to communicate a combustion actuating chamber (15) formed above a piston (20) with a crankchamber (18). At least one pair of the scavenging passages (32, 32) comprises, in large part, passage portions with partitions (32k, 32k). A cutout opening or through-hole that serves as a scavenging inlet (32a, 32a), the upper portion or whole of which is of a substantially triangular shape that is narrower towards its upper side, is formed in a lower end portion of at least one of the partitions (32k, 32k).

### BACKGROUND INFORMATION

1. Field of the Invention

The present invention relates to two-stroke internal combustion engines comprising one pair or a plurality of pairs of scavenging passages that adopt a reverse scavenging system, and more specifically to two-stroke internal combustion engines that are capable of suppressing the short-circuiting of fresh charge (unburnt air-fuel mixture), while at the same time also being capable of improving scavenging efficiency, combustion efficiency, and the like, as well as of improving the durability and output stability of the cylinder and the piston.

2. Background Art

Ordinarily, in standard two-stroke gasoline engines conventionally used in portable powered work machines, such as lawn mowers, chainsaws, etc., a spark plug is disposed at a head portion of a cylinder. An intake port, a scavenging port, and an exhaust port that are opened/closed by a piston are formed in a barrel portion of the cylinder. There are no independent strokes dedicated to intake and exhaust alone. And one cycle of the engine is completed with two strokes of the piston.

More specifically, by an up-stroke of the piston, an air-fuel mixture is drawn into a crankchamber below the piston from the intake port, while the air-fuel mixture is pre-pressurized by a down-stroke of the piston and the pre-pressurized air-fuel mixture is blown out from the scavenging port into a combustion actuating chamber above the piston, thereby exhausting the combustion waste gas to the exhaust port. In other words, the scavenging of the combustion waste gas is performed utilizing the gas flow of the air-fuel mixture.

For this reason, an unburnt air-fuel mixture often becomes mixed in the combustion waste gas (exhaust gas), the amount of fresh charge (unburnt air-fuel mixture) that is exhausted into the atmosphere without being used for combustion, that is, the so-called short circuited amount, is large, and fuel economy is inferior as compared to four-stroke engines. Further, I-IC (unburnt components of the fuel), CO (incomplete combustion components of the fuel), etc., which are noxious components, are contained in the exhaust gas in large amounts. Therefore, while the machines may be small in size, environmental pollution still is a concern, and there are such issues as how to accommodate emission regulations as well as demands for improved fuel economy, which are bound to become even more stringent in the years to come.

In view of such issues, various improvements have hitherto been proposed with regard to the shape and structure of scavenging passages as can be seen in Patent Documents 1 and 2 cited below, for example.

In addition, with respect to a two-stroke internal combustion engine comprising one pair or a plurality of pairs of scavenging passages that adopt a reverse scavenging system (Schnuerle-scavenging system) in such a manner as to communicate a combustion actuating chamber formed above a piston with a crankchamber, the present applicant has also previously proposed the forming of, in a planar member (gasket) fitted between a cylinder, into which the piston is fitted and inserted, and the crankcase, throttling holes or throttling cutout openings of fixed opening areas that are smaller than the sectional areas of the scavenging passages in order to throttle the vicinity of inlets of the scavenging passages as disclosed in Patent Document 3 cited below.

According to this proposal, since the throttling holes are provided near the scavenging inlets, the pressure difference between the crankchamber and a point in the scavenging passages downstream of the throttling holes becomes greater as compared to a case where no throttling holes are provided, and the air-fuel mixture of the crankchamber bursts out from the throttling holes at once and flow downstream thereof. In other words, the pressure and flow speed of the scavenging gas are increased as compared to a case where the vicinity of the scavenging inlets of the scavenging passages is not throttled, and the scavenging gas that has passed through the throttling holes is blown out into the combustion actuating chamber from scavenging outlets while expanding rapidly and generating a predetermined turbulence.

Thus, the atomization of fuel is facilitated, scavenging efficiency (trapping efficiency) improves, while at the same time combustion efficiency also improves. Consequently, the desired output is obtained with less fuel, the noxious components within the exhaust gas, THC [=total amount of unburnt gas components such as HC (hydrocarbon) and the like] in particular, can be reduced effectively and, further, fuel economy improves as well.

On the other hand, as two-stroke internal combustion engines of this kind, there are known, as can be seen in Patent Documents 4 and 5 cited below, those in which scavenging passages comprise, in large part, passage portions with partitions (formed by portions of a cylinder bore wall surface portion), and in which communication portions, bypass grooves or the like are provided in or adjacent to the scavenging passages in order to place (a portion of) the fresh charge within the scavenging passages or the crankchamber in direct contact with an outer circumferential portion (skirt portion) of the piston.

By thus placing the cold fresh charge in direct contact with the outer circumferential portion of the piston, the piston is effectively cooled, along with which a rise in the temperature of the cylinder in contact therewith is suppressed as well. Deformation of and damage to the piston and the cylinder caused by heat become less likely to occur, and it is held that durability and the like are thus improved.

[Patent Document 1] JP Patent Publication (Kokai) No. 2008-274804 A

[Patent Document 2] JP Patent Publication (Kokai) No. 11-315722 A (1999)

[Patent Document 3] JP Patent No. 4082868

[Patent Document 4] JP Patent Publication (Kokai) No. 2000-34926 A

[Patent Document 3] JP Patent Publication (Kokai) No. 06-257504 A (1994)

### SUMMARY

However, with the hitherto proposed techniques, it cannot be said that emission regulations and demands for improved fuel economy, which are bound to become even more stringent in the years to come, can be addressed to a sufficient extent, and the situation is such that there are strong demands for a new technique that is capable of suppressing the short-circuiting of fresh charge (unburnt air-fuel mixture) more than has been possible, while at the same time being capable of further improving scavenging efficiency, combustion efficiency, etc.

In addition, with respect to conventional techniques that cool the piston and suppress the rise in temperature of the cylinder by placing cold fresh charge in direct contact with the outer circumferential portion of the piston, such aspects as the following are not given sufficient consideration.

Specifically, with respect to such two-stroke internal combustion engines as those mentioned above, a greater amount of air-fuel mixture blown out from the scavenging passages into the combustion actuating chamber is preferable. Therefore, large opening areas had conventionally been set aside for scavenging inlets (cutout openings or through-holes) formed in lower end portions of the partitions. However, as the opening areas of the scavenging inlets become greater, the area of the cylinder bore wall surface that is the sliding surface for the piston decreases, and the area that supports and guides the piston becomes smaller. Thus, the stiffness (strength) of the cylinder drops, and there is a greater chance that the durability and output stability of the cylinder and the piston would be compromised.

The crown of the piston is exposed to high temperatures of 300° C. and above, and the side surface on the exhaust side is also similarly placed in a high-temperature state. In contrast, the intake side is cooled by fresh charge of approximately ambient temperature. Thus, the piston as a whole is placed under a significant temperature gradient.

In addition, with respect to the scavenging inlet portions, whereas the surface temperature of the partition portions is comparable to the combustion chamber temperature (250° C. to 300° C.) as they are formed integrally with the cylinder bore wall surface, the temperature of scavenging inlet portions in particular is considerably lower (50° C. to 100° C.) than that of the partition portions since the scavenging passages are filled with unburnt fuel-air mixture. The piston that slides within the cylinder thus must travel back and forth within a significant temperature gradient, such as that described above, that accompanies the presence/absence of partitions. Consequently, there is a greater chance that heat deformation resistance and durability would be compromised.

In addition, the piston slides within the cylinder while rocking to the left and right (because the upward and downward movement of the piston is converted into a rotational movement by a con rod and a crankshaft). Thus, if portions of the cylinder bore wall surface (i.e., left and right side surface portions) are wide-open as scavenging inlets, the area of the surface that supports the lateral movement of the piston becomes insufficient, the piston bearing capacity of the cylinder drops, and durability and output stability are compromised. In addition, the temperature gradient within the cylinder (particularly the horizontal section of the piston) becomes uneven, which may cause deformation by heat, accompanied by a drop in output. It may also cause biased contact of the piston relative to the cylinder, damage to the piston rings, and compromised durability of the piston itself as well.

The present invention is made in view of such circumstances, and an object thereof is to provide a loop-scavenged two-stroke internal combustion engine that is capable of effectively suppressing the short-circuiting of fresh charge, while at the same time being capable of further improving scavenging efficiency, combustion efficiency, etc, as well as of improving the durability and output stability of the cylinder and the piston.

In order to achieve the object above, a two-stroke internal combustion engine according to the present invention basically comprises one pair or a plurality of pairs of scavenging passages that adopt a reverse scavenging system in such a manner as to communicate a combustion actuating chamber, which is formed above a piston, with a crankchamber, wherein at least one pair of the scavenging passages comprises, in large part, passage portions with partitions, and a cutout opening or a through-hole, which serves as a scavenging inlet, the upper portion or the whole of which is substantially triangular where it becomes narrower towards the upper side, is formed in a lower end portion of at least one of the partitions.

In this case, in a preferred embodiment, the upper portion or the whole of at least one of the scavenging inlets is of a substantially triangular shape that widens at a substantially constant rate of change towards a lower end.

The scavenging inlet, the upper portion or the whole of which is of the substantially triangular shape, should preferably be such that its vertex angle is set at 130 degrees or less.

In yet another preferred embodiment, there are provided two pairs of the scavenging passages, and the scavenging inlet, the upper portion or the whole of which is of the substantially triangular shape, is formed in a lower end portion of at least one of the partitions of the scavenging passages located on the intake port side.

With a loop-scavenged two-stroke internal combustion engine according to the present invention, because (the upper portion or the whole of) the scavenging inlet formed in the lower end portion of the partition is of a substantially triangular shape that becomes narrower towards the upper side or, more preferably, is such that its opening width widens at a substantially constant rate of change towards the lower end, when the fresh charge that is compressed at the crankchamber flows into the scavenging passage through the scavenging inlet, the fresh charge is pushed in at a single focused point. Consequently, the flow speed of the scavenging flow increases and scavenging efficiency improves, thereby suppressing short-circuiting and reducing THC, while at the same time bringing about improvements in fuel economy and output.

In addition, because the scavenging inlet is of a substantially triangular shape, it becomes possible to reduce the opening area of the scavenging inlet as compared to a conventional device having a scavenging inlet of a substantially rectangular shape while securing an amount of air-fuel mixture that is necessary for the above-mentioned improvements in fuel economy and output. Thus, the area of the cylinder bore wall surface, which is the sliding surface for the piston, increases and, consequently, the stiffness (strength) of the cylinder increases, thereby making it possible to enhance the durability and output stability of the cylinder and the piston.

Further, because the scavenging inlet is of a substantially triangular shape, changes in the piston sliding area of the cylinder become more constant and gradual as compared to a conventional device having a substantially rectangular scavenging inlet, making it possible to avoid rapid changes in the piston bearing capacity of the cylinder. Consequently, deformation of and/or damage to the piston and the cylinder, as well as accompanying output drops and the like, become less likely, making it possible to further enhance the durability and output stability of the cylinder and the piston.

In addition, in relation to the temperature change accompanying the presence/absence of partitions, the rate of temperature change that the circumferential surface of the piston passing by the scavenging inlet portion is subjected to can be made substantially constant. Consequently, rapid temperature changes of the circumferential surface of the piston are prevented, thereby making it possible to improve the heat deformation resistance and durability of the piston.

Further, because the scavenging inlet is of a substantially triangular shape, thereby making the opening area smaller than its conventional counterpart, it becomes difficult for the highly viscous lubrication oil within the air-fuel mixture to enter the scavenging passages, and the separated lubrication oil thus accumulates within the crankcase. Consequently, such effects as a further improvement in seizure resistance, etc., are also achieved.

### BRIEF DESCRIPTION OF THE DRAWINGS

FIG. 1(A) is a vertical sectional view showing the main portion of the first embodiment of a loop-scavenged two-stroke internal combustion engine according to the present invention (present invention), and FIG. 1(B) is a vertical sectional view showing the main portion of an example of a conventional loop-scavenged two-stroke internal combustion engine (prior art).

FIG. 2 is a sectional view taken along and as viewed in the direction of arrows X-X in FIG. 1(A).

FIG. 3 is an enlarged view of the scavenging inlet portion shown in FIG. 1(A).

FIGS. 4(A) through (C) show graphs indicating the results of comparative experiments between the first embodiment (present invention) and the conventional example (prior art), where FIGS. 4(A), (B) and (C) respectively indicate THC emission, output (power) and specific fuel consumption (S.F.C.).

FIG. 5 is a sectional view of the second embodiment corresponding to the sectional view of the first embodiment shown in FIG. 2.

FIGS. 6(A) through (D) are enlarged partial vertical sectional views showing variations of the first and second embodiments.

FIGS. 7(E) and (F) are enlarged partial vertical sectional views showing other variations of the first and second embodiments.

### DESCRIPTION OF SYMBOLS

1 Two-stroke internal combustion engine (first embodiment)
2 Two-stroke internal combustion engine (second embodiment)
10 Cylinder
15 Combustion actuating chamber
18 Crankchamber
20 Piston
31 First scavenging passage
32 Second scavenging passage
31a, 32a Scavenging inlet
31b, 32b Scavenging outlet
31c, 32c Guide wall surface
33 Intake port
34 Exhaust port

### DETAILED DESCRIPTION OF THE PREFERRED EMBODIMENTS

Embodiments of the present invention are described below with reference to the drawings.

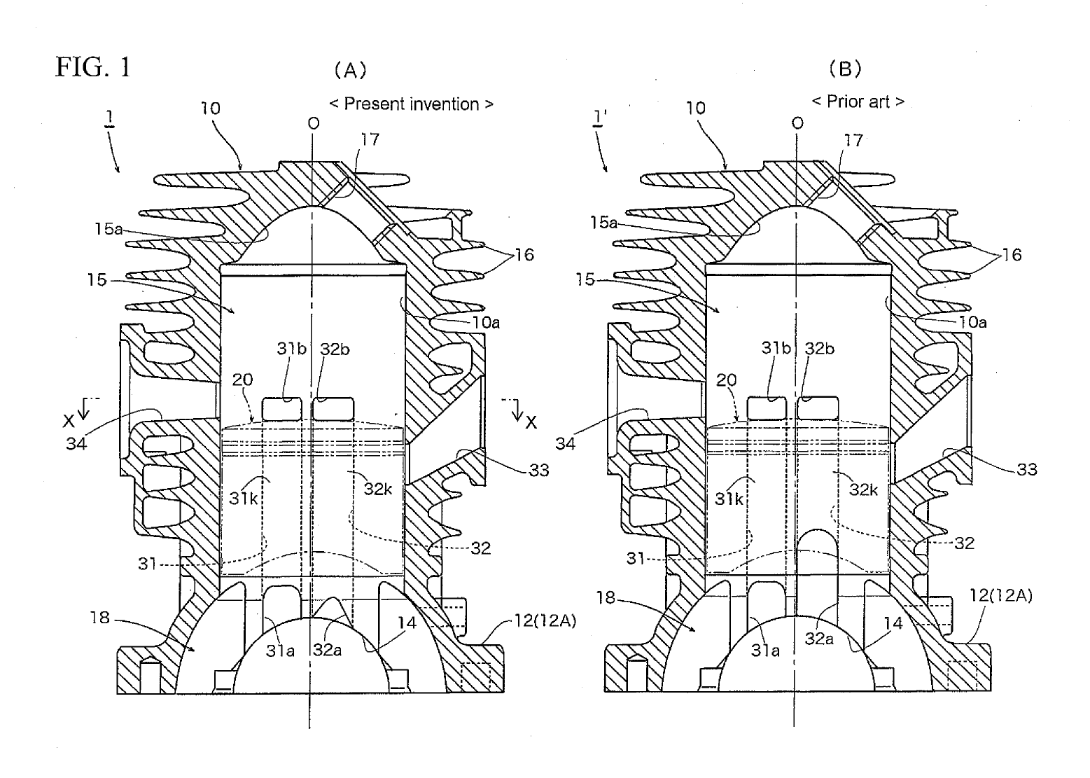

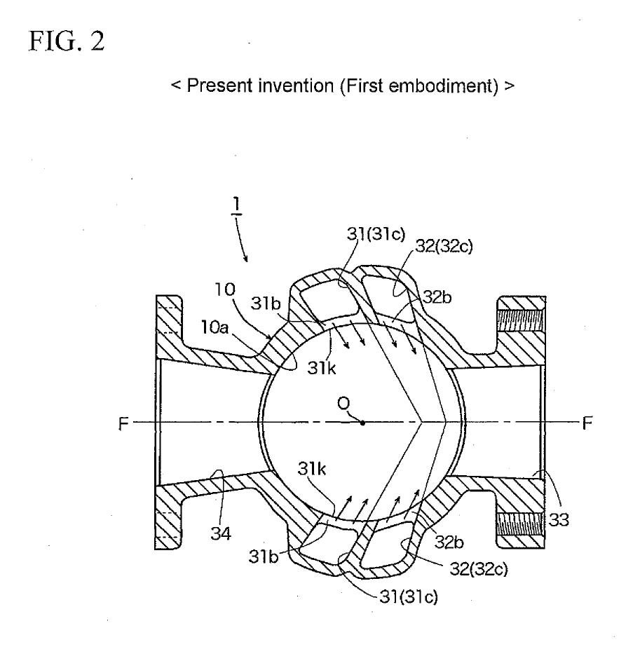

FIG. 1(A) is a vertical sectional view of an embodiment (first embodiment) of a loop-scavenged two-stroke internal combustion engine according to the present invention, and FIG. 1(B) is a vertical sectional view of a conventional example of a loop-scavenged two-stroke internal combustion engine. FIG. 2 is a sectional view taken along and as viewed in the direction of arrows X-X in FIG. 1(A). With respect to the engines of the first embodiment of the present invention and of the conventional example, corresponding parts or parts with like functions are designated with like reference numerals.

A description is provided below mainly with regard to portions that differ between an engine 1 of the first embodiment (present invention) and an engine 1′ of the conventional example (prior art).

The illustrated loop-scavenged two-stroke internal combustion engine 1 is a small air-cooled two-stroke gasoline engine of a four-port scavenging system used in portable powered equipment and the like, comprising a cylinder 10 in which a piston 20 is inserted and fitted, wherein an upper crankcase 12A, which constitutes the upper half of a crankcase 12, is integrally formed below the cylinder 10. An unillustrated lower crankcase is fastened in a sealed state below the upper crankcase 12A by means of, for example, four through bolts. The crankcase 12 defines a crankchamber 18 below the cylinder 10, and rotatably supports, via a main bearing, a crankshaft that reciprocates the piston 20 via a con rod.

Plural cooling fins 16 are provided on an outer circumferential portion of the cylinder 10. A squish dome shaped (hemispherical) combustion chamber portion 15a constituting a combustion actuating chamber 15 is provided at a head portion of the cylinder 10. A mounting hole (internal thread portion) 17 by which a spark plug (not shown) is installed is formed in the combustion chamber portion 15a.

In addition, an exhaust port 34 is provided on one side of the barrel portion of the cylinder 10, and an intake port 33 is provided on the other side of the barrel portion at a lower position than the exhaust port 34 (in FIG. 2, the exhaust port 34 and the intake port 33 are shown as if they are located at the same height).

In addition, in the two-stroke internal combustion engine 1 of the present embodiment, a pair of first scavenging passages 31, 31 located on the side of the exhaust port 34 and a pair of second scavenging passages 32, 32 located on the opposite side to the exhaust port 34 (i.e., on the side of the intake port 33), which adopt a reverse scavenging system (Schnuerle-scavenging system), are provided from the cylinder 10 to the upper crankcase 12A. The first and second scavenging passages 31, 31 and 32, 32 are so provided as to be symmetrical about a central vertical section F-F that bisects the intake port 33 and the exhaust port 34.

The first and second scavenging passages 31, 31 and 32, 32 are, in large part, passage portions with partitions 31k, 31k and 32k, 32k, respectively. Their lower ends open to a main bearing receiving face (half-cylindrical surface) 14 of the upper crankcase 12A.

At lower end portions of the respective partitions 31k, 31k and 32k, 32k of the scavenging passages 31, 31 and 32, 32, cutout openings 31a, 31a, and 32a, 32a of predetermined shapes (described later) and which serve as scavenging inlets are respectively formed.

In addition, rectangular first scavenging outlets 31b, 31b and second scavenging outlets 32b, 32b that open into the combustion actuating chamber 15 are respectively provided at the upper ends (downstream ends) of the first scavenging passages 31, 31 and the second scavenging passages 32, 32. Here, the first scavenging outlets 31b, 31b and the second scavenging outlets 32b, 32b are provided at the same height, and their upper end height is made lower than the upper end of the exhaust port 34 by a predetermined amount. Thus, the first scavenging outlets 31b, 31b and the second scavenging outlets 32b, 32b are such that, when the piston 20 moves downward, both pairs open simultaneously following a slight delay from the exhaust port 34.

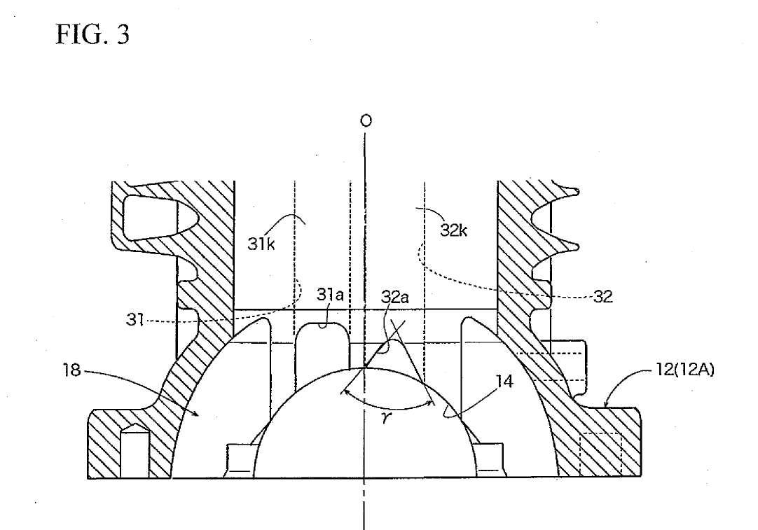

In addition, in the present embodiment, the scavenging inlets (cutout openings) 32a, 32a formed in the lower end portions of the partitions 32k, 32k of the second scavenging passages 32, 32 located on the side of the intake port 33 are of a substantially triangular shape that becomes narrower towards the upper side. More specifically, they are of a substantially triangular shape where, as shown enlarged in FIG. 3, the left and right sides that form a vertex angle γ are substantially formed of straight lines except for the vicinity of the vertex (rounded corner portion from manufacturing), that is, a substantially triangular shape whose opening width widens at a substantially constant rate of change towards the lower end. The opening area and height of the scavenging inlets (cutout openings) 32a, 32a are made to be smaller and lower than the opening area and height of the substantially rectangular scavenging inlets (cutout openings) 31a, 31a formed in the first scavenging passages 31, 31 located on the side of the exhaust port 34.

The scavenging inlets (cutout openings) 32a, 32a of the substantially triangular shape have their vertex portions located at center portions thereof in their width direction, and the vertex angles γ thereof are set at 130 degrees or below.

The shapes of the respective cutout openings 31a, 31a and 32a, 32a of the first and second scavenging passages 31, 31 and 32, 32 of the conventional example (prior art) are substantially rectangular as in the cutout openings 31a, 31a of the first scavenging passages 31, 31 in the present embodiment. The opening area and height of the scavenging inlets (cutout openings) 32a, 32a formed in the second scavenging passages 32, 32 located on the side of the intake port 33 in the prior art are made to be larger and higher than the opening area and height of the scavenging inlets (cutout openings) 31a, 31a formed in the first scavenging passages 31, 31 located on the side of the exhaust port 34, and are such that they are generally open wider.

With the two-stroke internal combustion engine 1 of the present embodiment thus configured, as the pressure in the crankchamber 18 drops in the up-stroke of the piston 20, an air-fuel mixture from an air-fuel mixture generating means, such as a carburetor or the like that is not shown in the drawings, is drawn into and captured in the crankchamber 18 from the intake port 33.

As the air-fuel mixture within the combustion actuating chamber 15 above the piston 20 is then ignited to explode and combust, the piston 20 is pressed downward by the combustion gas. In this down-stroke of the piston 20, the air-fuel mixture within the crankchamber 18 and the scavenging passages 31, 31 and 32, 32 is compressed by the piston 20, while at the same time the exhaust port 34 is opened first, and as the piston 20 moves further downward, the respective scavenging outlets 31b, 31b and 32b, 32b at the downstream ends of the scavenging passages 31, 31 and 32, 32 are opened simultaneously. During this scavenging period in which the scavenging outlets 31b, 31b and 32b, 32b are opened, the air-fuel mixture compressed inside the crankchamber 18 is pushed into the scavenging passages 31, 31 and 32, 32 from the scavenging inlets 31a, 31a and 32a, 32a, while at the same time being drawn towards the combustion actuating chamber 15, blown out towards the cylinder bore wall surface 10a on the opposite side to the exhaust port 34 (i.e., on the side of the intake port 33) as scavenging flows from the scavenging outlets 31b, 31b and 32b, 32b at a predetermined horizontal scavenging angle, and made to collide with the wall surface and turn around, thereby pushing out the combustion waste gas to the exhaust port 34.

Here, because in the loop-scavenged two-stroke internal combustion engine 1 of the present embodiment the scavenging inlets (cutout openings) 32a, 32a formed in the lower end portions of the partitions 32k, 32k of the second scavenging passages 32, 32 are of the substantially triangular shape that becomes narrower towards the upper side, or more specifically of the substantially triangular shape whose opening width widens at a substantially constant rate of change towards the lower end, when the fresh charge that is compressed at the crankchamber 18 flows into the scavenging passages through the scavenging inlets 32a, 32a, the fresh charge is pushed in at a single focused point. Consequently, the flow speed of the scavenging flow increases and scavenging efficiency improves, thereby suppressing short-circuiting and reducing THC, while at the same time bringing about improvements in fuel economy, and output.

In addition, because the scavenging inlets 32a, 32a are of a substantially triangular shape and the opening areas of the scavenging inlets are made smaller than those of a conventional device having substantially rectangular scavenging inlets, the flow speed of the scavenging flow becomes even faster. Consequently, a further reduction in THC, and further improvements in fuel economy and output are achieved. Further, because the opening areas of the scavenging inlets are made small, the area of the cylinder bore wall surface, which is the sliding surface for the piston, increases, as a result of which the stiffness (strength) of the cylinder increases, making it possible to enhance the durability and output stability of the cylinder and the piston.

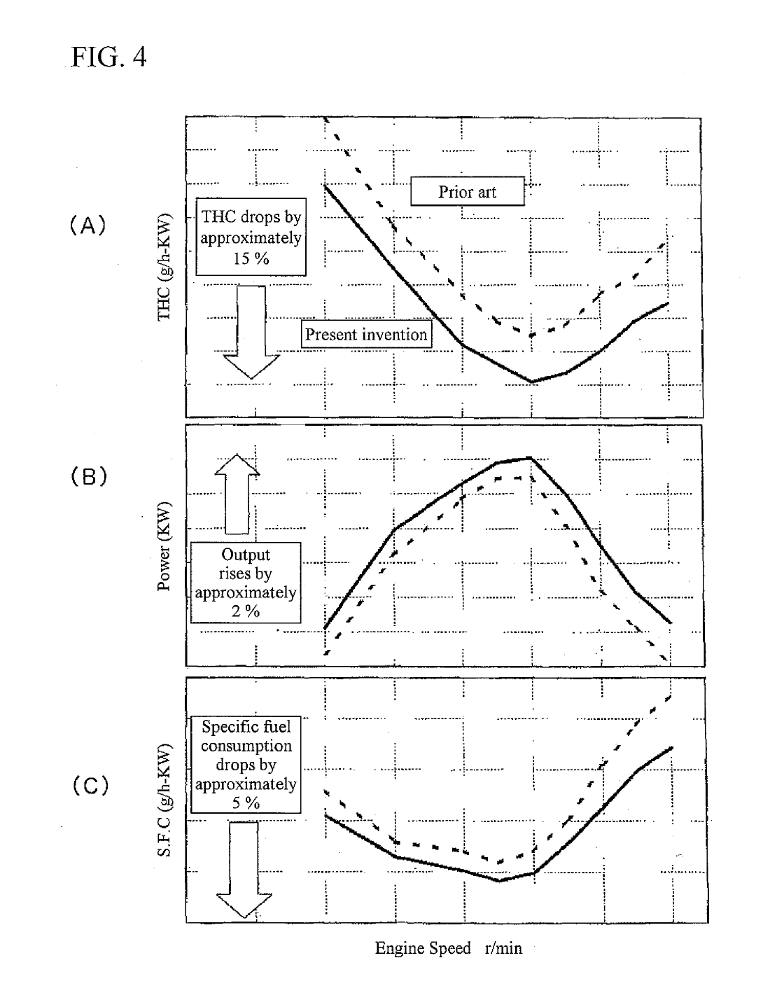

In fact, comparative experiments where the present embodiment (present invention) and the conventional example (prior art) were operated under the same conditions produced the results shown in FIGS. 4(A) through (C). FIG. 4(A) indicates THC emission, (B) output (power), and (C) specific fuel consumption (S.F.C.). From these results, it was confirmed that with the present invention, as compared to the prior art and across the entire operating revolution rate range (6,000 to 11,000 rpm), THC drops by approximately 15%, output rises by approximately 2%, and specific fuel consumption drops by approximately 5%.

Further, because the scavenging inlets 32a, 32a are of a substantially triangular shape, changes in the piston sliding area of the cylinder 10 become more constant and gradual as compared to a conventional device having substantially rectangular scavenging inlets, making it possible to avoid rapid changes in the piston bearing capacity of the cylinder 10. Consequently, deformation of and/or damage to the piston 20 and the cylinder 10, as well as accompanying output drops and the like, become less likely, making it possible to further enhance the durability and output stability of the cylinder 10 and the piston 20.

Further, the rate of temperature change that the circumferential surface of the piston passing by the scavenging inlet portion is subjected to in relation to temperature changes accompanying the presence/absence of partitions becomes substantially constant. Consequently, rapid temperature changes of the circumferential surface of the piston are prevented, thereby making it possible to improve the heat deformation resistance and durability of the piston.

In addition, since the scavenging inlets 32a, 32a are of a substantially triangular shape and their opening areas are made small, it becomes difficult for the highly viscous lubrication oil within the air-fuel mixture to enter the scavenging passages, and the separated lubrication oil thus accumulates within the crankcase. Consequently, such effects as a further improvement in seizure resistance, etc., are achieved.

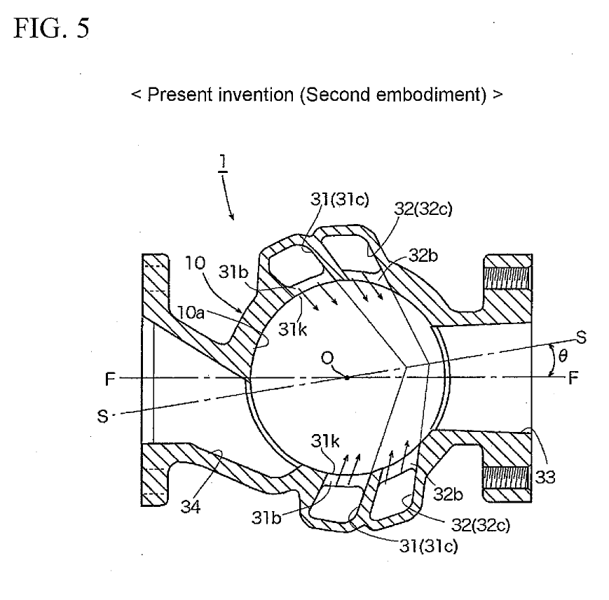

FIG. 5 shows a horizontal section of the second embodiment of a two-stroke internal combustion engine according to the present invention (corresponding to FIG. 2 which shows a horizontal section of the first embodiment). With respect to a two-stroke internal combustion engine 2 of the second embodiment, the scavenging passages 31, 31 and 32, 32 are so provided as to be symmetrical about an inclined vertical section S-S that is inclined, as viewed planarly, by a predetermined angle θ relative to a central vertical section F-F that bisects the intake port 33. Further, the exhaust port 34 is so provided as to be eccentric relative to the central vertical section F-F as viewed planarly. In all other respects, it is configured in the same manner as the first embodiment.

With the two-stroke internal combustion engine 2 of the second embodiment thus configured, too, it has been confirmed that substantially similar working effects as those of the first embodiment are achieved.

It is noted that although in the embodiments above, the substantially triangular scavenging inlet (cutout opening) 32a is formed in both of the partitions 32k, 32k of the scavenging passages 32, 32 located on the side of the intake port 33 among the two pairs of scavenging passages 31, 31 and 32, 32, the substantially triangular scavenging inlet 32a may also be formed in only one of the partitions 32k, 32k instead.

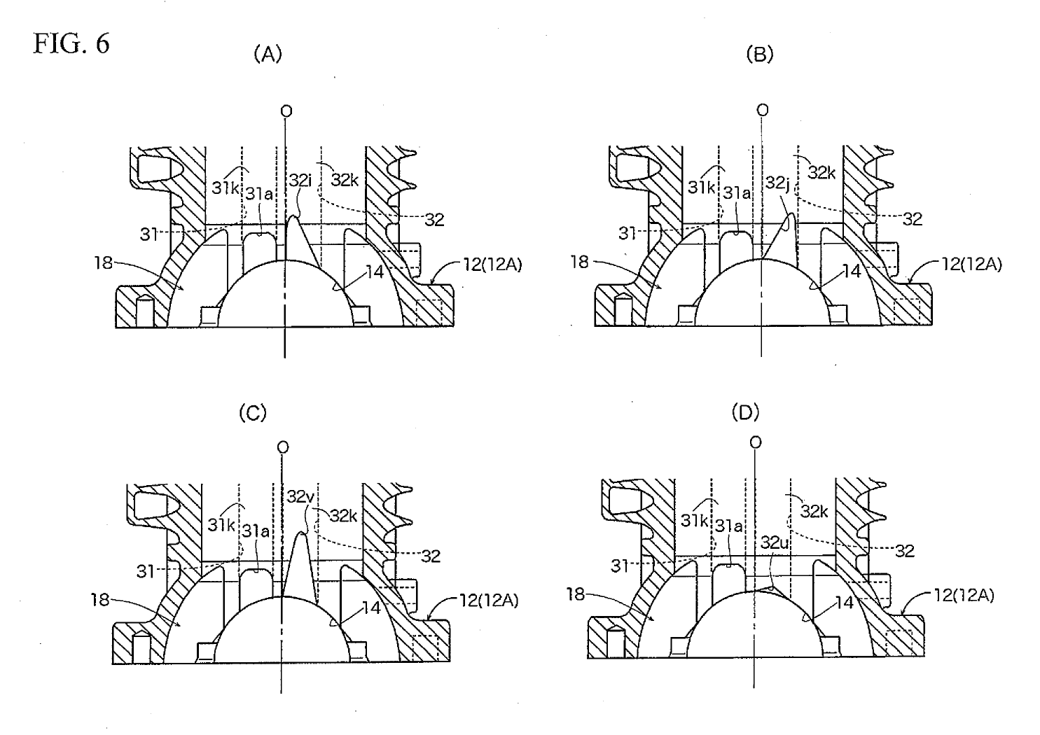

In addition, with respect to the substantially triangular scavenging inlets 32a, 32a, besides the example where the vertex portions are located at the center portions in the width direction, they may instead have such shapes as those of scavenging inlets 32i and 32j shown in FIGS. 6(A) and (B) where the vertex portions are skewed to one side in the width direction (i.e., the shape of a substantially right-angled triangle or a parallelogram including a substantially right-angled triangle). In addition, with respect to the opening height thereof, even in cases where they, in order to meet the demanded air-fuel mixture amount, open up to a position that is higher than the height of the scavenging inlet 31a on the exhaust port side as is the case with scavenging inlets 32i, 32j and 32v respectively shown in FIGS. 6(A), (B) and (C), because the opening width widens at a constant rate of change towards the lower end, a throttling effect (an effect where fresh charge is pushed in at a single focused point) is achieved by virtue of the substantially triangular shape without compromising the heat deformation resistance of the cylinder and the piston.

Further, where it is possible to design the opening height of the scavenging inlet low as in scavenging inlet 32u shown in FIG. 6(D), the throttling effect produced by virtue of the substantially triangular shape can be added while securing sufficient heat deformation resistance of the cylinder and the piston by way of the partitions. Here, in order to attain clear throttling effects, it is preferable that the vertex angle γ of the scavenging inlet be 130° or below.

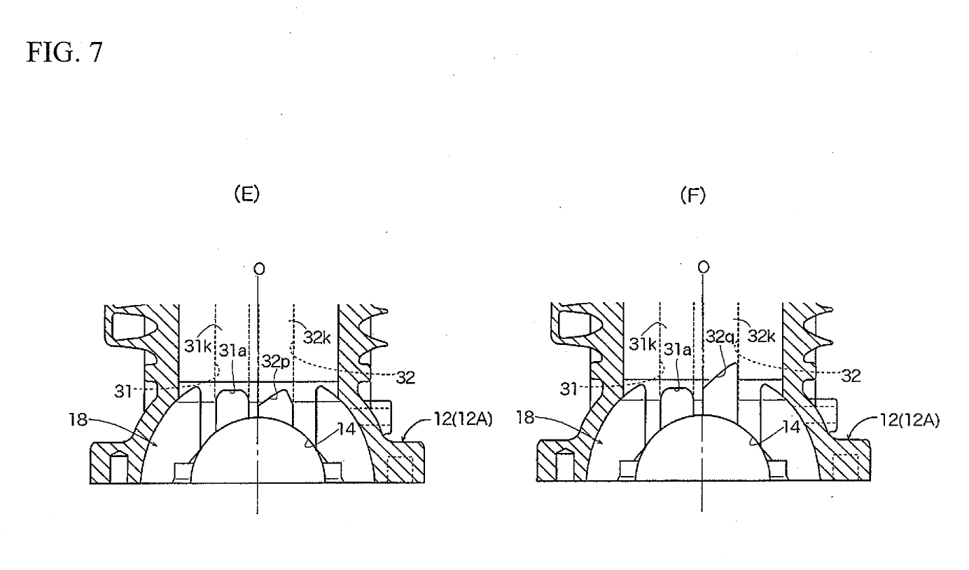

In addition, while the scavenging inlets 32a, 32i, 32j, 32v and 32u mentioned above are defined as being such that their overall shapes are substantially triangular where they become narrower towards the upper side, they are by no means limited as such. The shape of the scavenging inlet may instead be such that, as in scavenging inlets 32p and 32q respectively shown in FIGS. 7(E) and (F) for example, its upper portion is of a substantially triangular shape that becomes narrower towards the upper side (preferably with a vertex angle γ of 130° or below), and its lower portion is of a substantially rectangular shape; the overall shape thus substantially being a pentagon, a quadrilateral (trapezium), or the like. By thus having only the upper portion be of a substantially triangular shape, too, the above-mentioned throttling effect can still be attained, and the required air-fuel mixture amount and heat deformation resistance can be secured.

What is claimed is:

1. A two-stroke internal combustion engine comprising one pair or a plurality of pairs of scavenging passages that adopt a reverse scavenging system in such a manner as to communicate with a combustion actuating chamber formed above a piston with a crankchamber, wherein at least one pair of the scavenging passages comprises:
in large part, passage portions with partitions; and
a cutout opening or through-hole that serves as a scavenging inlet formed in a lower end portion of at least one of the partitions, the scavenging inlet including an upper portion or the whole of which is of a substantially triangular shape that is narrower towards its upper side.

2. The two-stroke internal combustion engine according to claim 1, wherein the upper portion or the whole of at least one of the scavenging inlets is of a substantially triangular shape that widens at a substantially constant rate of change towards its lower end.

3. The two-stroke internal combustion engine according to claim 1, wherein a vertex angle of the scavenging inlet is set at 130 degrees or below.

4. The two-stroke internal combustion engine according to claim 2, wherein a vertex angle of the scavenging inlet is set at 130 degrees or below.

5. The two-stroke internal combustion engine according to claim 1, comprising two pairs of the scavenging passages, wherein the scavenging inlet formed in the lower end portion of at least one of the partitions of the scavenging passages is located on the side of an intake port.

6. The two-stroke internal combustion engine according to claim 2, comprising two pairs of the scavenging passages, wherein the scavenging inlet formed in the lower end portion of at least one of the partitions of the scavenging passages is located on the side of an intake port.

7. The two-stroke internal combustion engine according to claim 3, comprising two pairs of the scavenging passages, wherein the scavenging inlet formed in the lower end portion of at least one of the partitions of the scavenging passages is located on the side of an intake port.

8. The two-stroke internal combustion engine according to claim 4, comprising two pairs of the scavenging passages, wherein the scavenging inlet formed in the lower end portion of at least one of the partitions of the scavenging passages is located on the side of an intake port.
